(19) United States
(12) Patent Application Publication
(10) Pub. No.: US 2017/0060421 A1
(43) Pub. Date: Mar. 2, 2017

(54) System and Method to Support Shingled Magnetic Recording Hard Drives in a Storage System

(71) Applicant: Dell Products, LP, Round Rock, TX (US)

(72) Inventors: William P. Dawkins, Austin, TX (US); Kevin T. Marks, Georgetown, TX (US)

(21) Appl. No.: 14/841,105

(22) Filed: Aug. 31, 2015

(51) Int. Cl. G06F 3/06

(52) U.S. Cl. CPC G06F 3/0604; G06F 3/0631; G06F 3/0644; G06F 3/0658; G06F 3/0689

(57) ABSTRACT

A storage system includes a processor, a controller, and first and second plurality of data storage devices. The controller communicates with the processor, and receives read and write requests for a redundant array of independent disks (RAID) array from the processor. The first plurality of data storage devices communicates with the controller. The first data storage devices are allocated as data drives in the RAID array, and are first type data storage devices. The second plurality of data storage devices communicates with the controller. The second plurality of data storage devices are allocated as parity drives in the RAID array, and are second type data storage devices.

### FIELD OF THE DISCLOSURE

The present disclosure generally relates to information handling systems, and more particularly relates to a system and method to support shingled magnetic recording hard drives in a storage system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

One subsystem of an information handling system is a storage subsystem. A storage subsystem can be implemented using a redundant array of independent disks (RAID). A RAID storage subsystem can include a RAID controller and a RAID array. The RAID array can include a plurality of physical disks (PDs) to store information that is presented to the information handling system as being stored on a virtual disk (VD) even though the storage of the information is distributed among the PDs.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram of a storage system of the information handling system according to a specific embodiment of the present disclosure;

FIG. 3 is a diagram of a portion of a data storage device within the information handling system according to a specific embodiment of the present disclosure;

FIG. 4 is a diagram of a disk array in the information handling system according to a specific embodiment of the present disclosure; and

FIG. 5 is a flow diagram illustrating a method for allocating a redundant array of independent disks (RAID) array according to a specific embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

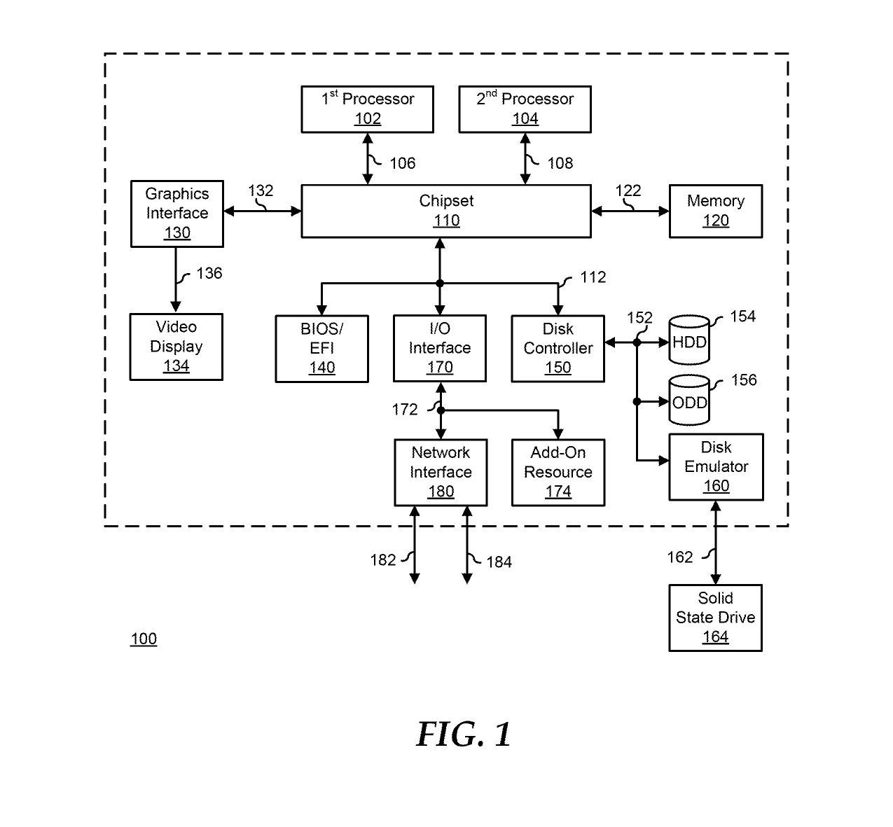

FIG. 1 shows an information handling system 100. For purposes of this disclosure, the information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network server or storage device, a switch router or other network communication device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communications between the various hardware components.

Information handling system 100 can also include one or more buses operable to transmit information between the various hardware components. Information handling system 100 can include devices or modules that embody one or more of the devices or modules described above, and operates to perform one or more of the methods described above. Information handling system 100 includes a processors 102 and 104, a chipset 110, a memory 120, a graphics interface 130, a basic input and output system/extensible firmware interface (BIOS/EFI) module 140, a disk controller 150, a disk emulator 160, an input/output (I/O) interface 170, and a network interface 180. Processor 102 is connected to chipset 110 via processor interface 106, and processor 104 is connected to chipset 110 via processor interface 108. Memory 120 is connected to chipset 110 via a memory bus 122. Graphics interface 130 is connected to chipset 110 via a graphics interface 132, and provides a video display output 136 to a video display 134. In a particular embodiment, information handling system 100 includes separate memories that are dedicated to each of processors 102 and 104 via separate memory interfaces. An example of memory 120 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 140, disk controller 150, and I/O interface 170 are connected to chipset 110 via an I/O channel 112. An example of I/O channel 112 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 110 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/EFI module 140 includes BIOS/EFI code operable to detect resources within information handling system 100, to provide drivers for the resources, initialize the resources, and access the resources.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a small computer serial interface (SCSI) interface, a serial attached SCSI (SAS) interface, a USB interface, a proprietary interface, or a combination thereof. Disk emulator 160 permits a solid-state drive 164 to be connected to information handling system 100 via an external interface 162. An example of external interface 162 includes a USB interface, an IEEE 1194 (Firewire) interface, a proprietary interface, or a combination thereof. Alternatively, solid-state drive 164 can be disposed within information handling system 100.

I/O interface 170 includes a peripheral interface 172 that connects the I/O interface to an add-on resource 174 and to network interface 180. Peripheral interface 172 can be the same type of interface as I/O channel 112, or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral channel 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board or add-in card disposed within information handling system 100, a device that is external to the information handling system, or a combination thereof.

Network interface 180 represents a NIC disposed within information handling system 100, on a main circuit board of the information handling system, integrated onto another component such as chipset 110, in another suitable location, or a combination thereof. Network interface device 180 includes network channels 182 and 184 that provide interfaces to devices that are external to information handling system 100. In a particular embodiment, network channels 182 and 184 are of a different type than peripheral channel 172 and network interface 180 translates information from a format suitable to the peripheral channel to a format suitable to external devices. An example of network channels 182 and 184 includes InfiniBand channels, Fibre Channel channels, Gigabit Ethernet channels, proprietary channel architectures, or a combination thereof. Network channels 182 and 184 can be connected to external network resources (not illustrated). The network resource can include another information handling system, a data storage system, another network, a grid management system, another suitable resource, or a combination thereof.

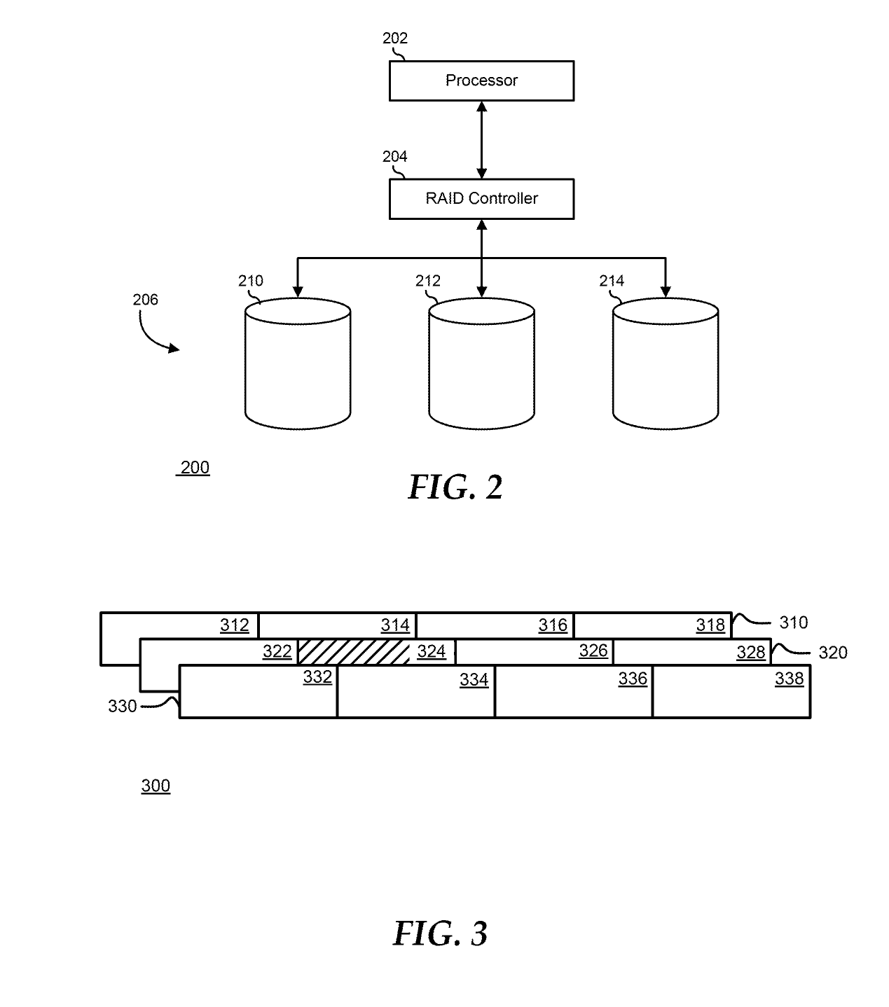

FIG. 2 shows a block diagram of a storage system 200 of the information handling system 100 according to a specific embodiment of the present disclosure. The storage system 200 includes a processor 202, a redundant array of independent disks (RAID) controller 204, and a RAID array 206. RAID array 206 includes data storage devices 210, 212, and 214. Data storage devices 210, 212, and 214 represent one or more independent data storage devices that provide a readable and writable storage medium for storage system 200, and that are configurable by RAID controller 204 into the elements of RAID array 206. As such, storage devices 210, 212, and 214 can include hard disk drives (HDDs), shingle magnetic recording (SMR) drives, re-writable optical disk drives (ODDs), solid state drives (SSDs), other types of readable and writable storage media, or a combination thereof. RAID controller 204 operates to store data in RAID array 206 by mirroring data across multiple data storage device 210, 212, and 214, by striping data across the data storage devices, by storing parity data across the data storage devices, by storing parity data in one or more dedicated parity data storage devices, by striping data across the dedicated parity data storage devices, or a combination thereof. For example, RAID controller 204 can implement RAID array 206 using a standard RAID level arrangement, such as RAID 3, RAID 4, RAID 5, RAID 6, or another standard RAID level, or using a non-standard RAID arrangement, as needed or desired. As such, RAID controller 204 stores data for storage system 200 in stripes or rows which include multiple logical blocks from one or more of data storage devices 210, 212, and 214, where one or more of the logical blocks includes calculated parity data or mirrored data. An example of a data storage device includes a Small Computer System Interconnect (SCSI) device, a Serial AT Attach (SATA) device, another type of data storage device, or a combination thereof.

In an embodiment, RAID controller 204 operates to reconstruct the data stored on a failed data storage device 210, 212, or 214, or from an unreadable logical block on one of the data storage devices. Such failures can occur as a result of component failures in a failing data storage device 210, 212, or 214, damage to some or all of the storage media of the failing data storage device, contaminants on a portion of the storage media, problems that may occur when data is written to the logical block, or based upon other failure mechanisms. RAID controller 204 reconstructs the data from a failed data storage device 210, 212, or 214, or from the unreadable logical block using the calculated parity data or mirrored data associated with the failed data storage device or unreadable logical block that is stored on the other data storage devices.

FIG. 3 shows a diagram of portion 300 of a data storage device, such as storage device 210 of FIG. 2, according to a specific embodiment of the present disclosure. The portion 300 includes tracks 310, 320, and 330 for writing and reading data in the data storage device. The tracks 310, 320, and 330 can each include multiple storage blocks. For example, track 310 includes blocks 312, 314, 316, and 318, the track 320 includes blocks 322, 324, 326, and 328, and the track 330 includes blocks 332, 334, 336, and 338. In an embodiment, the data storage device can be a shingled magnetic recording (SMR) device. In an embodiment, the width or pitch of a drive track 310, 320, or 330 for reading data in a hard drive is narrower than the pitch for writing data. Thus, the tracks 310, 320, 330 in the data storage device can be implemented using SMR, such that tracks can overlap as they are written as shown in FIG. 3. In an embodiment, the data blocks 312-318, 322-328, and 332-338 can be aligned in a configuration that resembles the way shingles are laid out on the roof of a house. For example, conventional hard disk drives record data by writing non-overlapping magnetic tracks parallel to each other, while shingled magnetic recording drives write new tracks that overlap part of the previously written magnetic track, leaving the previous track thinner and allowing for higher track density.

In this embodiment, the configuration of the data blocks 312-318, 322-328, and 332-338 can increase storage density and overall per-drive storage capacity of the disk drive as compared to a standard or conventional hard disk drive. In an embodiment, the overlapping of the tracks 310, 320, and 330 may result in the writing to track 330 overwrites adjacent tracks, such as track 320. In this situation, track 320 is rewritten at the same time that track 330 is written. This data writing process can be slower than the data writing process in a conventional hard disk drive. In an embodiment, the writing of data can be manage it in the firmware of the RAID controller 204, such that storing data to the RAID array 206 can be presented in an interface like any other hard disk. In an embodiment, if the data storage devices 210, 212, and 214 of FIG. 2 are SMR devices, the data storage device can be host-managed and an operating system can only write sequentially to certain regions of the data storage device.

In an embodiment, if the storage array 206 has an input/output (IO) access pattern in that the storage devices 210, 220, and 230 are written to often, one or more of the storage devices 210, 212, and 214 that are configured as SMR drives can have lower IO performance than one or more of the storage devices that are configured as standard hard disk drives. In an embodiment, data can only be written at the end of a track 310, 320, or 330 in a linear fashion. When a block is modified in the middle of a track, such as block 324 in track 320, the data storage device 210 can marks the block as unused, as shown by the lines in block 324 of FIG. 3, and can remap the block address to a current location of a write pointer in an active track, such as block 338 of track 330. The block 324 then cannot be reused until a garbage collection process is completed in response to the block 324 of track 320 being marked as unused. Thus, SMR drives are particularly well suited to IO patterns that include data being modified infrequently relative to the amount of times the data is read. In an embodiment, an SMR drive may have a modified data to read data ratio, such as Modified:Read, that is much less than for standard hard disk drives.

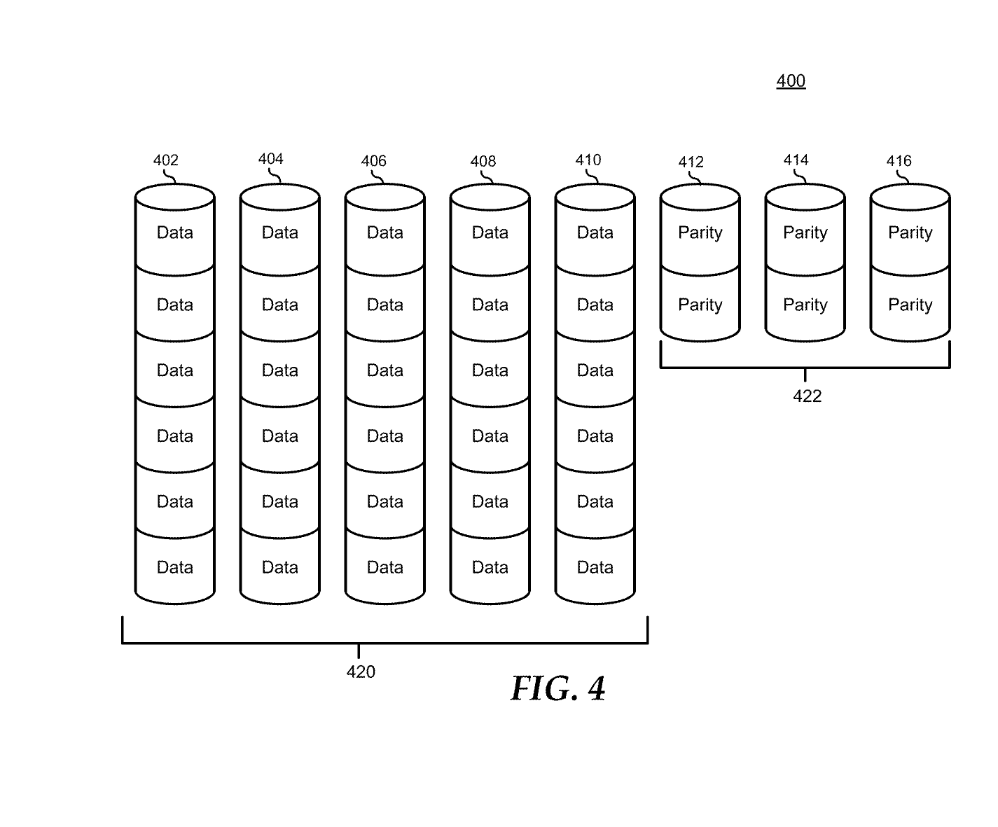

FIG. 4 is a diagram of a RAID array 400 in the information handling system 100 according to a specific embodiment of the present disclosure. The RAID array 400 includes data storage devices 402, 404, 406, 408, 410, 412, 414, and 416 (402-416). In an embodiment, the disk array 400 can be configured by the controller by the RAID controller 204 of FIG. 2 and the processor 202 of FIG. 2 can access the RAID array to read data from and write data to the data storage devices 402-416. For example, the RAID controller can configure the data storage devices 402-416 in a RAID 4-SMR format. In an embodiment, the RAID array 400 can include two different types of data storage devices, such as SMR devices and standard hard disk drives. For example, data storage devices 402-410 can be a first type of data storage device, such as SMR devices, and the data storage devices 412-416 can be a second type of data storage device, such as standard hard disk drive. The RAID controller 204 can configure the RAID array 400 into two different sets of data storage devices 420 and 422 based on the type of data storage device.

In an embodiment, the first set of data storage devices 420 can be configured as dedicated data drives, and the second set of data storage devices 422 can be configured as dedicated parity drives. The RAID controller 204 can allocate the SMR data storage devices 402-410 to the first set of data storage devices 420, and can allocate the standard data storage devices 412-416 to the second set of storage devices 422. In an embodiment, the RAID array 400 can be configured such that parity data is not located with the SMR data storage devices 402-410, but the parity data is stored on the dedicated parity data storage devices 412-416. Thus, the dedicated data storage devices, data storage devices 402-410, have a different storage technology than the dedicated parity device, data storage devices 412-416.

In an embodiment, SMR data storage devices 402-410 can have higher capacities than standard hard disk drives. For example, each individual SMR data storage device 402-410 can have a storage capacity of 12 TB, and each individual the standard hard disk drive data storage device 412-416 can have a storage capacity of 4 TB. In different embodiments, the SMR data storage devices 402-410 can have different storage capacities, such as 10 TB, 20 TB, or the like, without deviating from the scope of the current disclosure. In different embodiments, the SMR data storage devices 402-410 can have different storage capacities, such as 1 TB, 2 TB, or the like, without deviating from the scope of the current disclosure.

In an embodiment, the data storage devices 412-416 can be concatenated into a single parity container equal to the storage capacity of a single SMR data storage device 402, 404, 406, 408, or 410. In an embodiment, the concatenation of the data storage devices 412-416 can enable the RAID controller 204 to sequentially map the memory blocks of data storage devices. For example, the first block of data storage device 414 can be mapped in the RAID controller 204 immediately after the last block of data storage device 412, and the first block of data storage device 416 can be mapped immediately after the last block of data storage device 414. In an embodiment, the parity data can be striped on the data storage devices 412-416 instead of the data storage devices being concatenated. In this situation, IO load on each of the data storage devices 412-416 can be equally distributed across the parity drives.

When the RAID controller 204 receives a write request including data to store in the RAID array 400, the RAID controller can write the data to one or more current block locations of an active track in the data storage devices 402-410. The controller 204 can then update the parity data for data in the data dedicated data storage devices 402-410. The updated parity data can then be written to the dedicated parity data storage devices 412-416.

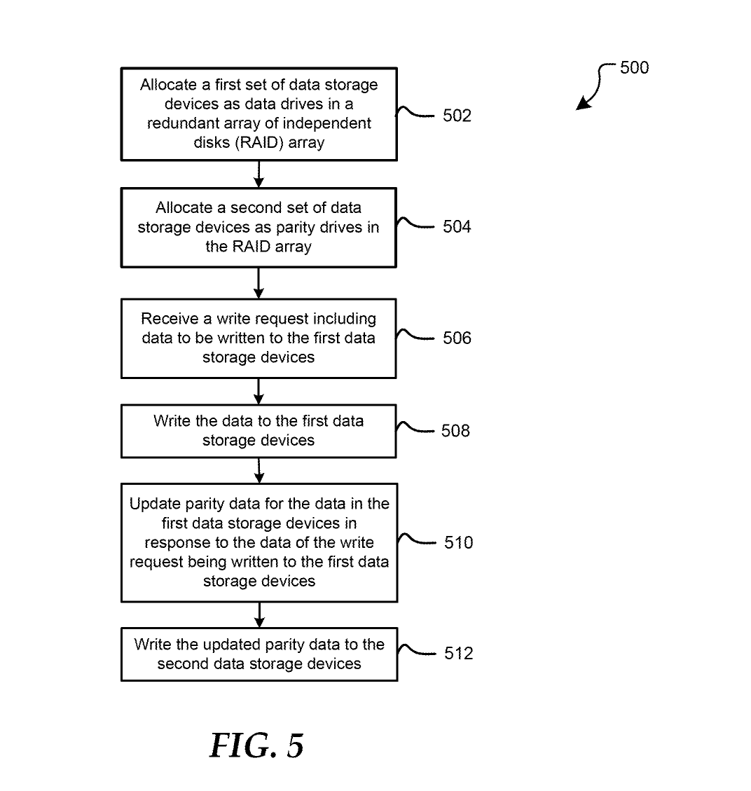

FIG. 5 shows a flow diagram of a method 500 for allocating a redundant array of independent disks (RAID) array in a storage system according to a specific embodiment of the present disclosure. At block 502, a first set of data storage devices are allocated as data drives in the RAID array. In an embodiment, the first set of the data storage devices are allocated by a controller of the storage system. In an embodiment, each of the first data storage devices is a first type data storage device. In an embodiment, the first type of data storage device is a shingled magnetic recording data storage device.

At block 504, a set plurality of the data storage devices are allocated as parity drives in the RAID array. In an embodiment, each of the second data storage devices is a second type data storage device. In an embodiment, the second type of data storage device is a standard hard disk drive. In an embodiment, a first storage capacity of each of the first data storage devices is greater than a second storage capacity of each of the second data storage devices.

At block 506, a write request including data to store in the first data storage devices is received at the controller. The data is written to the first data storage devices at block 508. At block 510, parity data for data in the first data storage devices is updated in response to the data being written to the first data storage devices. The updated parity data to the second data is written to the second data storage devices at block 512. In an embodiment, the second data storage devices are concatenated together to form a single parity data storage device In an embodiment, the second data storage devices are striped to equally distribute input/output requests to the second data storage devices.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a consumer electronic device, a network server or storage device, a switch router, wireless router, or other network communication device, a network connected device (cellular telephone, tablet device, etc.), or any other suitable device, and can vary in size, shape, performance, price, and functionality.

The information handling system can include memory (volatile (e.g. random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various input and output (I/O) devices, such as a keyboard, a mouse, a video/graphic display, or any combination thereof. The information handling system can also include one or more buses operable to transmit communications between the various hardware components. Portions of an information handling system may themselves be considered information handling systems.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The device or module can include software, including firmware embedded at a device, such as a Pentium class or PowerPC™ brand processor, or other such device, or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A storage system comprising:
a processor;
a controller to communicate with the processor, the controller to receive read and write requests for a redundant array of independent disks (RAID) array from the processor;
a first plurality of data storage devices to communicate with the controller, the first data storage devices allocated as data drives in the RAID array, wherein each of the first data storage devices is a first type data storage device; and
a second plurality of data storage devices to communicate with the controller, the second plurality of data storage devices allocated as parity drives in the RAID array, wherein each of the second data storage devices is a second type data storage device.

2. The storage system of claim 1, the controller to receive a write request including data to store in the first data storage devices, to write the data to the first data storage devices, to update parity data for data in the first data storage devices in response to writing the data to the first data storage devices, and to write the updated parity data to the second data storage devices.

3. The storage system of claim 1, wherein a first storage capacity of each of the first data storage devices is greater than a second storage capacity of each of the second data storage devices.

4. The storage system of claim 1, wherein the first type of data storage device is shingled magnetic recording data storage device.

5. The storage system of claim 1, wherein the second type of data storage devices is a standard hard disk drive.

6. The storage system of claim 1, wherein the second data storage devices are concatenated together to form a single parity data storage device.

7. The storage system of claim 1, wherein the second data storage devices are striped to equally distribute input/output requests to the second data storage devices.

8. A method comprising:
configuring, by a controller, a plurality of data storage devices as a redundant array of independent disks (RAID) array;
allocating, by the controller, a first set of the data storage devices as data drives in the RAID array, wherein each of the first set of the data storage devices is a first type data storage device; and
allocating, by the controller, a second set of the data storage devices as parity drives in the RAID array, wherein each of the second set of data storage devices is a second type data storage device.

9. The method of claim 8, further comprising:
writing, by the controller, data to the data drives;
updating parity data for data in the data drives in response to the data being written to the data drives; and
writing the updated parity data to the parity drives.

10. The method of claim 8, wherein a first storage capacity of each of the first data storage devices is greater than a second storage capacity of each of the second data storage devices.

11. The method of claim 8, wherein the first type of data storage device is a shingled magnetic recording data storage device.

12. The method of claim 8, wherein the second type of data storage device is a standard hard disk drive.

13. The method of claim 8, wherein the second data storage devices are concatenated together to form a single parity data storage device.

14. The method of claim 8, wherein the second data storage devices are striped to equally distribute input/output requests to the second data storage devices.

15. A method comprising:
allocating, by a controller, a first plurality of data storage devices as data drives in a redundant array of independent disks (RAID) array, wherein each of the first data storage devices is a first type data storage device;
allocating, by the controller, a second plurality of data storage devices as parity drives in the RAID array, wherein each of the second data storage devices is a second type data storage device;
receiving, at the controller, a write request including data to store in the first data storage devices;
writing the data to the first data storage devices;
updating parity data for data in the first data storage devices in response to writing the data to the first data storage devices; and
writing the updated parity data to the second data storage devices.

16. The method of claim 15, wherein a first storage capacity of each of the first data storage devices is greater than a second storage capacity of each of the second data storage devices.

17. The method of claim 15, wherein the first type of data storage device is shingled magnetic recording data storage device.

18. The method of claim 15, wherein the second type of data storage device is a standard hard disk drive.

19. The method of claim 15, wherein the second data storage devices are concatenated together to form a single parity data storage device.

20. The method of claim 15, wherein the second data storage devices are striped to equally distribute input/output requests to the second data storage devices.
